(19) United States
(12) Patent Application Publication
(10) Pub. No.: US 2019/0053355 A1
(43) Pub. Date: Feb. 14, 2019

(54) LIGHTING SYSTEM, OPERATING DEVICE, AND MAPPING METHOD FOR USE IN LIGHTING SYSTEM

(71) Applicant: Panasonic Intellectual Property Management Co., Ltd., Osaka (JP)

(72) Inventors: Kentaro YAMAUCHI, Hyogo (JP); Shigeo NAKAMURA, Osaka (JP)

(21) Appl. No.: 16/053,034

(22) Filed: Aug. 2, 2018

(30) Foreign Application Priority Data
Aug. 10, 2017 (JP) 2017-155334

(51) Int. Cl. H05B 37/02

(52) U.S. Cl. CPC H05B 37/0272; G06F 3/0482

(57) ABSTRACT

Lighting system includes luminaires and operating device that associates identification information held by each of the luminaires with layout information of the luminaires. The operating device includes a display that displays, based on the layout information, marks each corresponding to one of the luminaires and a mark group including, among the marks, at least two marks corresponding one-to-one to at least two luminaires among the luminaires. The mark group is displayed in a distinguishable manner from one or more marks not included in the mark group.

### CROSS REFERENCE TO RELATED APPLICATION

This application claims the benefit of priority of Japanese Patent Application Number 2017-155334 filed on Aug. 10, 2017, the entire content of which is hereby incorporated by reference.

### BACKGROUND

### 1. Technical Field

The present disclosure relates to an operating device that associates identification information of a luminaire with layout information, a lighting system that includes the operating device, and a mapping method for use in the lighting system.

### 2. Description of the Related Art

Conventionally, a lighting system that includes luminaires and an operating device such as a tablet PC is known (see reference, for example, to Japanese Unexamined Patent Application Publication No. 2016-103372).

### SUMMARY

Immediately after luminaires have been installed on, for example, a structure (e.g., a ceiling) of a building, a relationship between identification information (e.g., identifier) held by each of the luminaires and layout information indicating the locations of the luminaires in the building is unknown. As such, it is not possible to control the lighting of the luminaires. Therefore, the identification information of each luminaire is associated with the layout information using an operating device. Since the association was conventionally made by associating one by one the pieces of identification information of luminaires and layout information, this required a huge amount of efforts in some cases.

The present disclosure has an object to provide a lighting system and so on, which enable easy association between the identification information of a luminaire and layout information.

A lighting system according to one aspect of the present disclosure includes: luminaires; and an operating device that associates identification information held by each of the luminaires and layout information of the luminaires. The operating device includes a display that displays marks and a mark group based on the layout information, the marks corresponding one-to-one to the luminaires, the mark group including, among the marks, at least two marks corresponding one-to-one to at least two luminaires among the luminaires. The mark group is displayed in a distinguishable manner from one or more marks not included in the mark group.

An operating device according to one aspect of the present disclosure includes: a display that displays marks and a mark group based on layout information of luminaires before associating identification information held by each of the luminaires with the layout information, the marks corresponding one-to-one to the luminaires, the mark group including, among the marks, at least two marks corresponding one-to-one to at least two luminaires among the luminaires.

Moreover, a mapping method according to one aspect of the present disclosure is a mapping method, which is for use in a lighting system including an operating device and luminaires, for associating identification information held by each of the luminaires with layout information of the luminaires. The mapping method includes: displaying, on the operating device, marks and a mark group based on the layout information, the marks each corresponding to one of the luminaires, the mark group including at least two marks among the marks; obtaining pieces of identification information, each being obtained from one of the luminaires; and associating, with the mark group displayed on the operating device, at least two pieces of identification information among the pieces of identification information obtained.

It is possible to easily associate the identification information of a luminaire with layout information.

### BRIEF DESCRIPTION OF DRAWINGS

The figures depict one or more implementations in accordance with the present teaching, by way of examples only, not by way of limitations. In the figures, like reference numerals refer to the same or similar elements.

FIG. 1 is a schematic diagram illustrating luminaires, a host controller, wireless controllers, and an operating device that are included in a lighting system according to Embodiment 1;

FIG. 2 is a diagram illustrating an example of a layout, inside a building, of the lighting system according to Embodiment 1;

FIG. 3 is a block diagram illustrating a configuration of the lighting system according to Embodiment 1;

FIG. 4 is a flowchart illustrating a mapping method for use in the lighting system according to Embodiment 1;

FIG. 5A is a diagram illustrating a display process and an information obtainment process in the mapping method for use in the lighting system according to Embodiment 1;

FIG. 5B is a diagram illustrating an association process in the mapping method for use in the lighting system according to Embodiment 1;

FIG. 6 is a diagram illustrating an association process in a mapping method for use in a lighting system according to a variation of Embodiment 1;

FIG. 7 is a flowchart illustrating a mapping method for use in a lighting system according to Embodiment 2;

FIG. 8 is a schematic diagram illustrating luminaires and an operating device that are included in a lighting system according to Embodiment 3; and

FIG. 9 is a block diagram illustrating a configuration of the lighting system according to Embodiment 3.

### DETAILED DESCRIPTION OF THE EMBODIMENTS

The following describes exemplary embodiments with reference to the drawings. Note that each of the embodiments described below is merely one specific example of the present disclosure. Accordingly, the numerical values, shapes, materials, elements, arrangement and connection of the elements, etc., indicated in the following embodiments are given merely by way of illustrations and are not intended to limit the scope of the present disclosure. Therefore, among the elements in the following embodiments, those not recited in any one of the independent claims defining the broadest concepts of the present disclosure are described as optional elements.

Note also that the figures are schematic illustrations and are not necessarily precise depictions. Moreover, in the figures, elements that are essentially the same share like reference signs. Accordingly, duplicate description is omitted or simplified.

### Embodiment 1

[1-1. Outline Configuration of Lighting System]

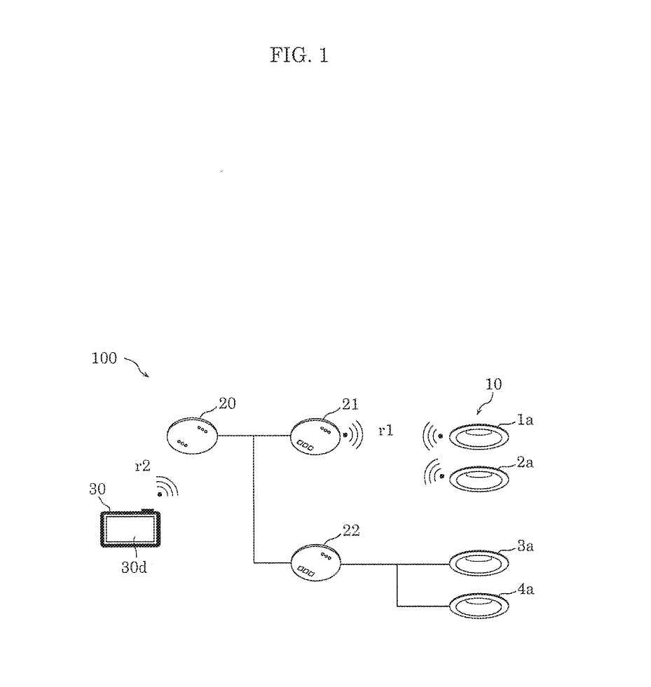

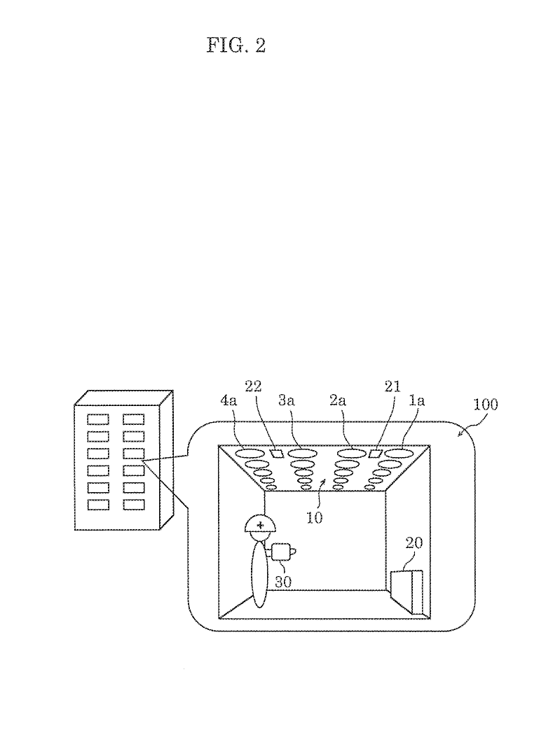

An outline configuration of lighting system 100 according to Embodiment 1 will be described with reference to FIG. 1 and FIG. 2.

FIG. 1 is a schematic diagram illustrating luminaires 1a, 2a, 3a, and 4a, host controller 20, wireless controllers 21 and 22, and operating device 30 that are included in lighting system 100. FIG. 2 is a diagram illustrating an example of a layout, inside a building, of lighting system 100 according to Embodiment 1.

Lighting system 100 includes luminaires 1a, 2a, 3a, and 4a, host controller 20, wireless controllers 21 and 22, and operating device 30. FIG. 1 illustrates four luminaires while FIG. 2 illustrates twenty luminaires, but more than hundred luminaires may be actually installed, for example, in the ceiling of a building in some cases. Hereinafter, a part or all of the luminaires illustrated in FIG. 1 or FIG. 2 are referred to as luminaires 10 in some cases.

As illustrated in FIG. 1, luminaires 1a and 2a are each capable of communicating with wireless controller 21 over radio r1. Luminaires 3a and 4a are each capable of communicating with wireless controller 22 via wired communication. The methods of communication over radio r1 include specified low power radio that uses a frequency in the 920 MHz or 2.4 GHz band, Zigbee®, Bluetooth®, and WiFi®. It should be noted that luminaires 1a and 2a may be each capable of communicating with wireless controller 21 via wired communication while luminaires 3a and 4a may be each capable of communicating with wireless controller 22 over radio r1.

Wireless controllers 21 and 22 are each capable of communicating with host controller 20 via wired communication, Note that wireless controllers 21 and 22 may be each capable of wirelessly communicating with host controller 20.

Host controller 20 is capable of communicating with operating device 30 over radio r2. The method of communication over radio r2 is a method different from the method of communication over radio r1. It should be noted that a method identical to the method of communication over radio r1 may be used as the method of communication over radio r2. Moreover, operating device 30 and host controller 20 may be configured to be able to communicate with each other through a connection terminal such as a USB via wired communication.

Operating device 30 is a setter that associates identification information held by each luminaire 10 and layout information indicating the locations of luminaires 10 (hereinafter referred to as “mapping” in some cases). The aforementioned mapping and the pairing of each luminaire 10 with wireless controller 21 or 22 enable host controller 20 to control the lighting of luminaires 10.

Lighting system 100 according to this embodiment includes luminaires 10 to be individually controlled by host controller 20 and at least two luminaires 10 to be controlled as a group by host controller 20. When mapping is performed in lighting system 100, luminaires 10 to be individually controlled are individually displayed whereas luminaires 10 to be controlled as a group are displayed in a group, on operating device 30.

[1-2. Configuration of Lighting System]

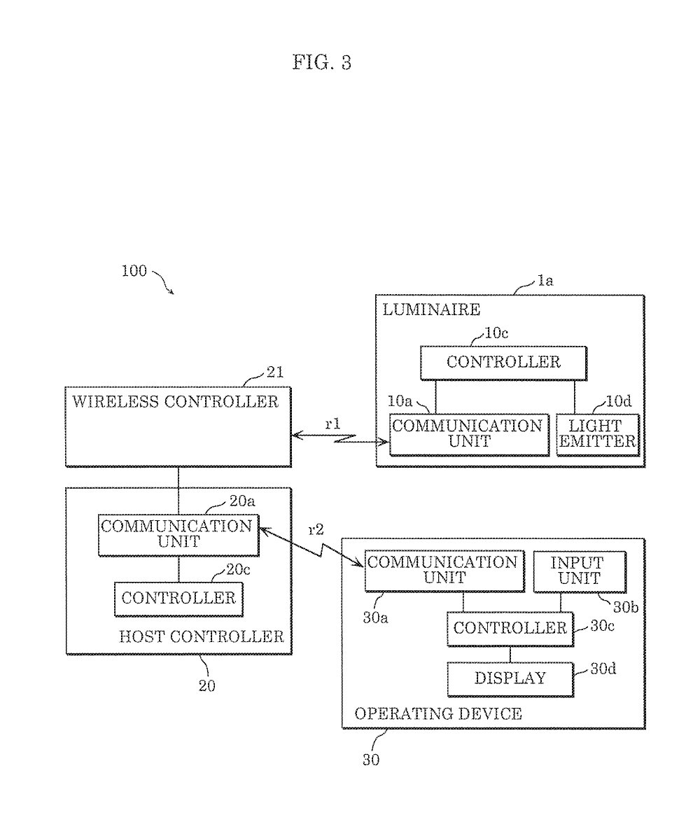

The following describes, with reference to FIG. 3, luminaire 10, host controller 20, wireless controllers 21 and 22, and operating device 30 which are included in lighting system 100. FIG. 3 is a block diagram illustrating the configuration of lighting system 100. Here, the description will be based around luminaire 1a, which is presented as a representative luminaire from among luminaires 10. Moreover, wireless controller 21 is presented as a representative wireless controller out of wireless controllers 21 and 22.

Luminaire 1a includes communication unit 10a, light emitter 10d, and controller 10c connected to communication unit 10a and light emitter 10d.

Light emitter 10d includes, for example, light-emitting diodes each of which emits white light, red light, green light, or blue light. Communication unit 10a includes, for example, an antenna and a wireless module, and communicates with wireless controller 21 over radio r1.

Controller 10c includes a central processing unit (CPU), random access memory (RAM), read-only memory (ROM), etc. Identification information (ID) such as a media access control (MAC) address or a unique device identifier (UDID) of luminaire 1a is stored in controller 10c. Controller 10c controls the lighting of light emitter 10d based on an instruction received, via communication unit 10a.

Host controller 20 includes communication unit 20a and controller 20c connected to communication unit 20a.

Wireless controller 21 is connected to communication unit 20a. Wireless controller 21 includes, for example, an antenna and a wireless module, and is provided outside host controller 20. Communication unit 20a communicates with luminaire 1a via wireless controller 21 and communicates with operating device 30 over radio r2. In FIG. 3, wireless controller 21 is provided outside host controller 20, but may be provided inside host controller 20 or form a single controller in which wireless controller 21 and host controller 20 are incorporated together as one.

Controller 20c includes a CPU, RAM, ROM, etc. After the mapping of luminaires 1a and pairing between each luminaire 1a and wireless controller 21 have been completed, controller 20c controls the lighting of luminaires 10 via wireless controller 21.

Operating device 30 is, for example, a tablet PC or a smart phone. Operating device 30 includes communication unit 30a, display 30d, input unit 30b, and controller 30c connected to communication unit 30a, display 30d, and input unit 30b.

Communication unit 30a includes, for example, an antenna and a wireless module. Communication 30a communicates with host controller 20 over radio r2, as has been mentioned above.

Display 30d displays identification information, layout information of luminaires 10, etc. Input unit 80b receives an input, from the user, for associating the identification information of luminaire 10 with the layout information. Operating device 30 includes a touch panel that has both functions of display 30d and input unit 30b.

Controller 30c includes a CPU, RAM. ROM, etc. Layout information indicating the locations of luminaires 10 is stored in controller 30c. In addition, controller 30c obtains the identification information of each luminaire 10 via host controller 20 and wireless controller 21, and stores the obtained identification information before mapping is performed.

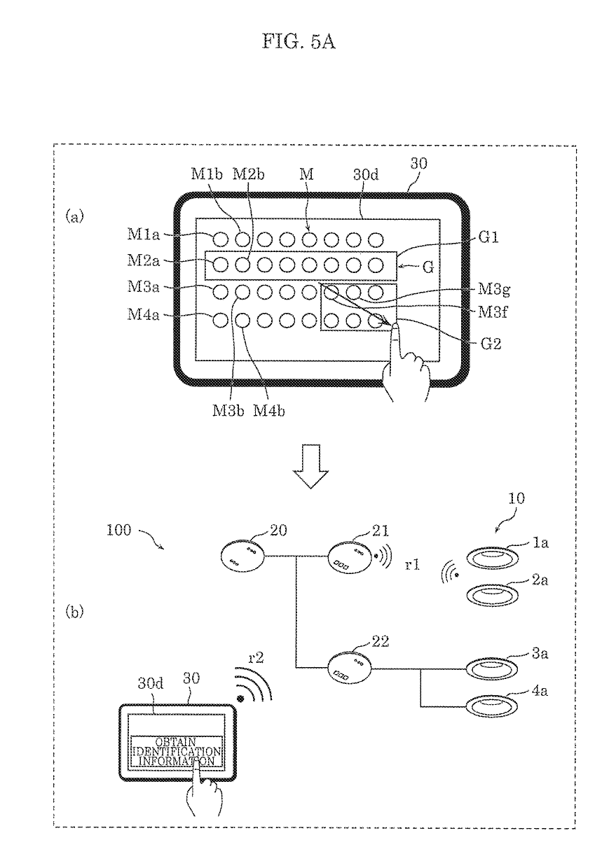

Controller 30c causes display 30d to display marks M corresponding one-to-one to luminaires 10, based on the layout information of luminaires 10 (see reference to (a) in FIG. 5A). Moreover, upon receiving, via input unit 30b, a selection input including at least two marks M among marks M displayed on display 30d, controller 30c creates mark group G that includes at least the two marks M that have been selected.

Controller 30c causes display 30d to display mark group G that has been created. Upon receiving, for mark group G that is displayed, an input of the identification information of at least two luminaires 10 corresponding one-to-one to at least the two marks M selected, controller 30c performs mapping.

After the mapping and pairing have been carried out in lighting system 100, luminaires 10 corresponding one-to-one to marks M included in mark group G are controlled as a group by host controller 20. Lighting system 100 according to this embodiment has a configuration in which mapping of luminaires 10 that are to be controlled as a group can be easily performed.

[1-3. Mapping Method in Lighting System]

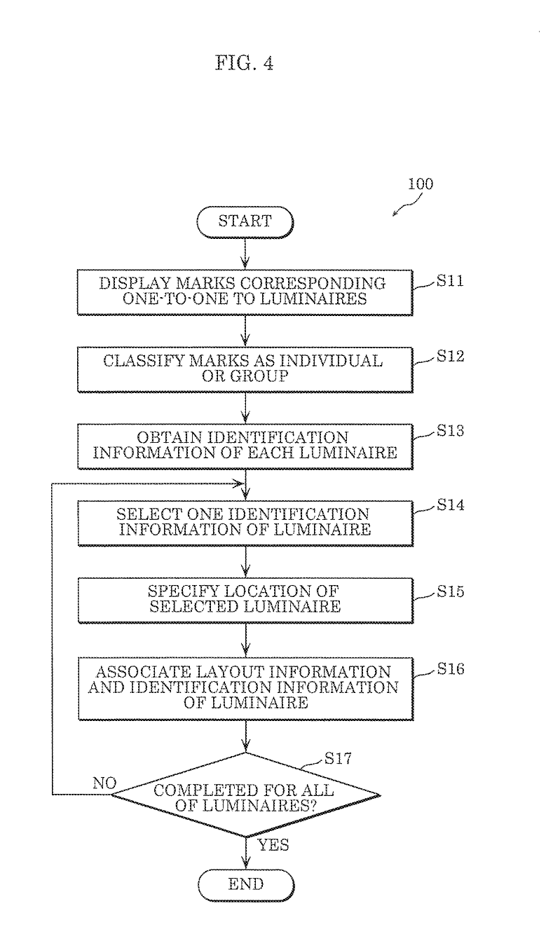

The following describes a mapping method for use in lighting system 100, with reference to FIG. 4 through FIG. 5B. Mapping refers to associating the identification information held by each luminaire 10 with layout information indicating the locations of luminaires 10 in a building, as has already been described above.

FIG. 4 is a flowchart illustrating the mapping method for use in lighting system 100. FIG. 5A is a diagram illustrating a display process and an information obtainment process in the mapping method for use in lighting system 100 whereas FIG. 5B is a diagram illustrating an association process in the mapping method.

First, marks M corresponding one-to-one to luminaires 10 are displayed on display 30d in operating device 30 (S11). Marks M are displayed based on the layout information of luminaires 10 which is held by controller 30c in operating device 30. In (a) in FIG. 5A, marks M1a, M1b, M2a, M2b, M3a, M3b, M4a and M4b, for example, among marks M are displayed in a row. The marks may be presented by graphic symbols, signs, letters, or pictographs.

Subsequently, marks M are classified as individual or group and then displayed (S12: display process). Marks M displayed on display 30d are firstly displayed individually, and then displayed as a part of mark group G upon the reception of an input as described below. More specifically, upon controller 30c's receiving a selection input including at least two marks M among marks M, mark group G is created and marks M that have been selected are displayed in the area of this mark group G. For example, controller 30c creates mark group G upon receiving, on display 30d, touch inputs for selecting marks M2a, M2b, etc. displayed on display 30d. With this, mark group G1 including marks M2a, M2b, etc., which is enclosed by a rectangular box, is displayed on display 30d, as illustrated in (a) in FIG. 5A. A Controller 30c also creates mark group G2 upon receiving, on display 30d, an input for enclosing marks M3g, M3f, etc. displayed in the lower right part of display 30d. With this, mark group G2 including marks M3g, M3f, etc., which is enclosed by a rectangular box, is displayed on display 30d. Mark group G may be displayed as a group by enclosing marks M by a rectangular box or by bringing the form or color of marks M into conformity.

Subsequently, the identification information of each luminaire 10 is obtained using operating device 30 (S13: information obtainment process). Operating device 30 obtains the identification information of each luminaire 10 via host controller 20 and wireless controllers 21 and 22, as illustrated in (b) in FIG. 5A.

The pieces of identification information obtained are displayed, for example, in the lower part of display 30d, as illustrated in (a) in FIG. 5B. In (a) in FIG. 5B, the letters “A” through “K” representing the pieces of identification information obtained from luminaires 10 are displayed below marks M. The presentation of identification information shall not be limited to alphabets, and may be numbers or MAC addresses per se.

Subsequently, one piece of identification information is selected from among the obtained pieces of identification information of luminaires 10 (S14). More specifically, the letter “H”, for example, is touched and thus selected from among the letters “A” through “K” displayed on display 30d, as illustrated in (a) in FIG. 5B.

Subsequently, the location of luminaire 10 corresponding to the selected identification information is specified (S15). When the identification information represented by the letter “H” is selected in Step S14, a flashing instruction is sent from operating device 30 to luminaire 10 and luminaire 10 having the identification information represented by the letter “H” flashes, as illustrated in (b) in FIG. 5B. By visually confirming the location of luminaire 10 that flashes, the user recognizes which mark M among marks M displayed on display 30d corresponds to luminaire 10 having the identification information represented by the letter “H”. Thus, the location of luminaire 10 that has been selected is specified.

Subsequently, the identification information of luminaire 10 is associated with the layout information (S16).

How the pieces of identification information of luminaire 10 are associated one by one with marks M displayed on display 30d is illustrated in (c) in FIG. 5B. When luminaire 10 that has been caused to flash in Step S15 corresponds to the location of mark M3c on display 30d, for example, the identification information of that luminaire 10 is associated with the layout information by mark M3c on display 30d being touched, as illustrated in (c) in FIG. 5B. More specifically, upon receiving a touch input for selecting one mark M3c displayed on display 30d while one piece of identification information represented by the letter “H” is being selected, controller 30c associates the identification information represented by the letter “H” of luminaire 10 with the layout information related to the location of mark M3c.

How the identification information of luminaire 10 is associated with mark group G1 displayed on display 30d is illustrated in (d) in FIG. 5B. When luminaire 10 that has been caused to flash in Step S15 corresponds to the location of mark group G1 on display 30d, for example, the identification information of that luminaire 10 is associated with the layout information by mark group G1 on display 30d being touched, as illustrated in (d) in FIG. 5B. More specifically, upon receiving a touch input for selecting mark group G1 that is enclosed by a rectangular box and displayed on display 30d while one piece of identification information “H” is being selected, controller 30c associates the identification information, of luminaire 10, which is represented by the letter “H”, with the layout information related to the location of mark group G1.

In (c) in FIG. 5B, the identification information is input by mark M3c, which is enclosed by a small region, being touched, but in (d) in FIG. 5B, the identification information is input by mark group G1, which is enclosed by a large region, being touched. Thus, the display of mark group G on display 30d enables an input of identification information by a simple and easy operation, compared to the case of inputting identification information into mark M that is individually displayed. Moreover, a strict position matching on display 30d is not required, and therefore, it is possible to reduce false input.

In the case of (d) in FIG. 53, the input identification information (e.g., identification information represented by the letter “H”) is displayed in mark group G1, but the exact position thereof in mark group G1 is not required. Accordingly, the input identification information may be placed, for example, in input order from left in the area of mark group G1. Furthermore, in the case of (c) and (d) in FIG. 5B, the form or color of mark M for which mapping has been completed may be changed and then displayed, so that whether or not mapping has been completed can be checked on display 30d. The form of mark M for which mapping has been completed may be changed, for example, from circle to double circle.

Subsequently, whether or not mapping has been completed for all of luminaires 10 is determined (S17). When luminaire 10 for which mapping is not performed is found (No in S17), Steps S14 through S16 are executed for that luminaire 10, When mapping has been completed for all of luminaires 10 (Yes in S17), mapping performed under lighting system 100 ends.

[1-4. Advantageous Effects Etc.]

Lighting system 100 according to this embodiment includes luminaires 10 and operating device 30 that associates identification information held by each of luminaires 10 with layout information of luminaires 10. Operating device 30 includes display 30d that displays marks M and mark group G based on the layout information, Marks M correspond one-to-one to luminaires 10 and mark group G includes, among marks M, at least two marks M corresponding one-to-one to at least two luminaires 10 among luminaires 10. Mark group G is displayed in a distinguishable manner from one or more marks M not included in mark group G.

Thus, with the display, on display 30d, of mark group G that includes at least two marks M, it is possible, in lighting system 100, to easily associate the identification information of luminaire 10 with the layout information.

Moreover, operating device 30 may include controller 30c that creates mark group G upon receiving a selection input including at least two marks M among marks M displayed on display 30d. After having created mark group G, operating device 30 may cause display 30d to display mark group G.

Thus, upon receiving, on display 30d, a selection input including at least two marks M, it is possible to easily create mark group G and easily associate the identification information of luminaire 10 with the layout information.

Furthermore, controller 30c may create mark group G upon receiving, as the selection input on display 30d, touch inputs for selecting at least two marks M among marks M displayed on display 30d. Still further, controller 30c may create mark group G upon receiving, as the selection input on display 30d, an input for enclosing at least two marks among marks M.

Furthermore, controller 30c may have layout information of luminaires 10. Upon receiving an input of the identification information of one luminaire 10 among luminaires 10, for one mark M among marks M displayed on display 30d, controller 30c may associate the layout information with the identification information.

Thus, it is possible to associate the identification information of luminaire 10 with the layout information upon the reception of the input of one luminaire 10 for mark M, and therefore, this can enhance the degree of freedom in mapping input.

What is more, controller 30c may have layout information of at least two luminaires 10 corresponding one-to-one to at least two marks included in mark group G. Upon receiving an input of the identification information of at least two luminaires 10, for mark group G displayed on display 30d, controller 30c may associate the layout information with the identification information.

Thus, it is possible to easily associate the identification information of luminaire 10 with the layout information upon the reception of the input of at least two luminaires 10 for mark group G.

Moreover, at least two luminaires 10 corresponding one-to-one to at least two marks included in mark group G may be controlled as a group.

With this, it is possible to control, as a group, luminaires 10 that belong to mark group G.

Operating device 30 according to this embodiment includes display 30d that displays marks M and mark group G based on layout information of luminaires 10 before associating identification information held by each of luminaires 10 with the layout information, Marks M correspond one-to-one to luminaires 10 and mark group G includes, among marks M, at least two marks M corresponding one-to-one to at least two luminaires 10 among luminaires 10.

Thus, the display, on display 30d, of mark group G including at least two marks M enables operating device 30 to easily associate the identification information of luminaire 10 with the layout information.

A mapping method, which is for use in lighting system 100 according to this embodiment including operating device 30 and luminaires 10, for associating identification information held by each of luminaires 10 with layout information of luminaires 10 includes: displaying, on operating device 30, marks M and mark group G based on the layout information, marks M corresponding one-to-one to luminaires 10, mark group G including at least two marks M among marks M; obtaining pieces of identification information, each being obtained from one of luminaires 10; and associating, with mark group G displayed on operating device 30, at least two pieces of identification information among the pieces of identification information obtained.

Thus, with the display process of displaying, on display 30d, mark group G including at least two marks M, it is possible to easily associate the identification information of luminaire 10 with the layout information in the associating process.

Moreover, the associating may include associating one-to-one, with marks M displayed on operating device 30, the pieces of identification information obtained.

Thus, it is possible to associate the identification information of luminaire 10 with the layout information upon the reception of the input of one luminaire 10 for mark M, and therefore, the degree of freedom in mapping input can be enhanced.

Furthermore, the obtaining and the associating are performed in the listed order after the displaying.

Thus, by executing the information obtainment process after the display process, it is possible to easily associate the identification information of luminaire 10 with the layout information in the association process.

[1-5. Variation]

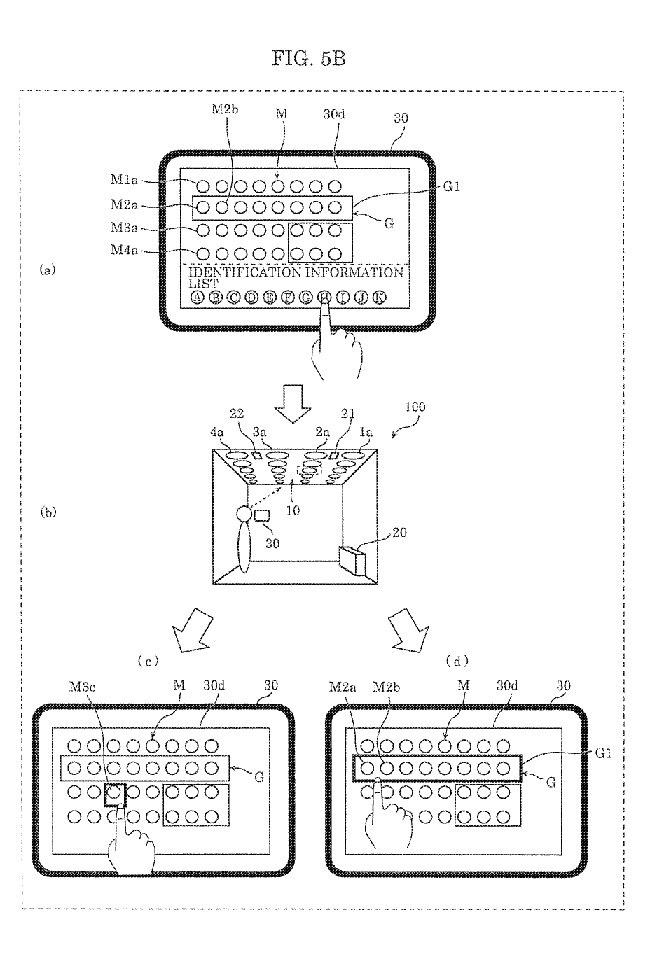

The following describes, with reference to FIG. 6, a mapping method for use in lighting system 100 according to a variation, FIG. 6 is a diagram illustrating an association process in the mapping method.

In the variation, marks M on display 30d are not placed on a map, but are listed in a chart as illustrated in (a) in FIG. 6. More specifically, marks M1a, M2a, M3a, and M4a, each being formed by a combination of alphabet letters and a number, are placed in each row in the chart. Moreover, “place” corresponding to each of marks M1a through M4a and whether each of marks M1a through M4a belongs to “individual” or “group” are displayed (S12). Furthermore, the pieces of identification information, of luminaires 10, which are represented by the letters “A” through “K” and obtained in Step S15, are displayed in the lower part of display 30d.

In this state, one piece of identification information is selected from among the obtained pieces of identification information of luminaires 10 (S14). More specifically, the letter “H”, for example, is touched and thus selected from among the pieces of identification information represented by the letters “A” through “K” and is displayed on display 30d, as illustrated in (a) in FIG. 6.

Subsequently, the location of luminaire 10 corresponding to the selected identification information is specified (S15). When the identification information represented by the letter “H” is selected in Step S14, a flashing instruction is sent from operating device 30 to luminaire 10 and luminaire 10 having the identification information represented by the letter “H” flashes, as illustrated in (b) in FIG. 6. By visually confirming the location of luminaire 10 that flashes, the user recognizes which of the locations, which are listed under the category “place” and are associated one-to-one with marks M displayed on display 30d, corresponds to luminaire 10 having the identification information represented by the letter “H”. Thus, the location of luminaire 10 that has been selected is specified.

Subsequently, the identification information of luminaire 10 is associated with the layout information (S16).

How the pieces of identification information of luminaires 10 are associated one by one with marks M displayed on display 30d is illustrated in (c) in FIG. 6. When luminaire 10 that has been caused to flash in Step S15 corresponds to the location “doorway” of mark M4a, for example, the identification information of that luminaire 10 is associated with the layout information by the “individual” section of mark M4a on display 30d being touched, as illustrated in (c) in FIG. 6.

How the identification information of luminaire 10 is associated with mark group G1 displayed on display 30d is illustrated in (d) in FIG. 6. When luminaire 10 that has been caused to flash in Step S15 corresponds to the location “room 1” of mark group G1, for example, the identification information of that luminaire 10 is associated with the layout information by the “group” section of mark group G1 on display 30d being touched, as illustrated in (d) in FIG. 6.

In (c) in FIG. 6, the identification information is input upon the “individual” section, which is enclosed by a small region, being touched, but in (d) in FIG. 6, the identification information is input upon the “group” section of mark group G1, which is enclosed by a large region, being touched. Thus, the display of mark group G on display 30d enables an input of identification information by a simple and easy operation, compared to the case of inputting identification information into mark M that is individually displayed. Moreover, a strict position matching on display 30d is not required, and therefore, it is possible to reduce false input.

### Embodiment 2

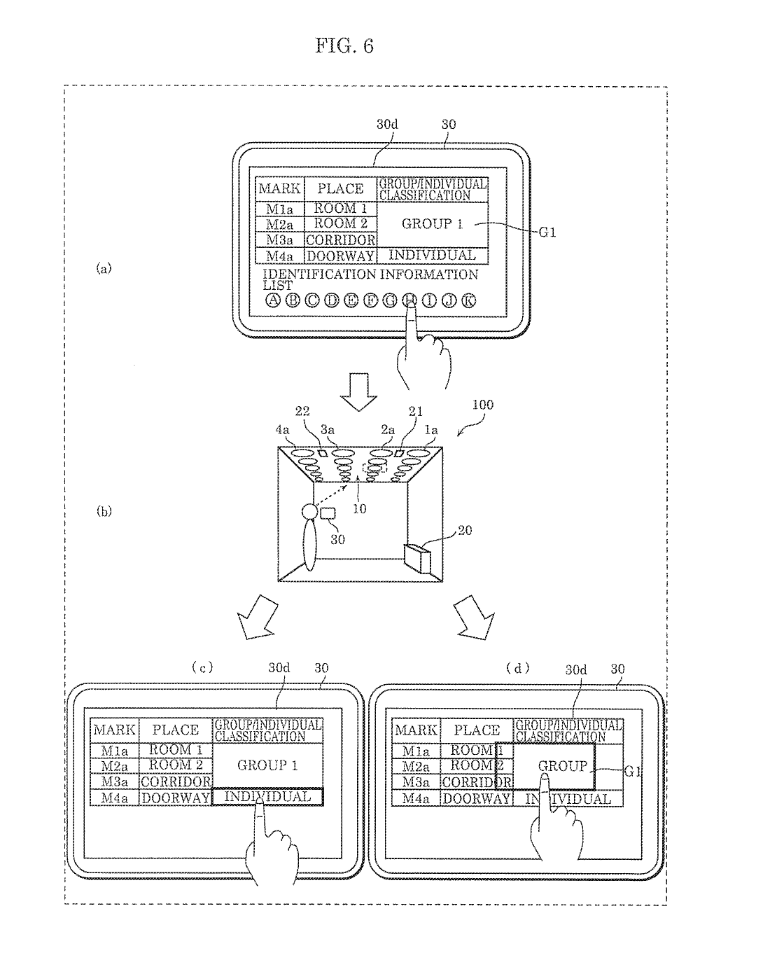

The following describes, with reference to FIG. 7, a mapping method for use in lighting system 100A according to Embodiment 2.

FIG. 7 is a flowchart illustrating the mapping method for use in lighting system 100A. In the mapping method for use in lighting system 100A, the displaying and the associating are performed in the listed order after the obtaining.

More specifically, after the identification information of each luminaire 10 has been obtained using the method identical to that described in Embodiment 1 (S10), marks M corresponding one-to-one to luminaires 10 are displayed (S11), classified as either “individual” or “group”, and then displayed (S12). After that, Steps S14 and S15 are executed in the manner identical to that described in Embodiment 1.

As in the mapping method for use in lighting system 100A according to Embodiment 2, even when the display process is executed, after the information obtainment process, it is possible to easily associate the identification information of luminaire 10 with the layout information in the next process of association process.

### Embodiment 3

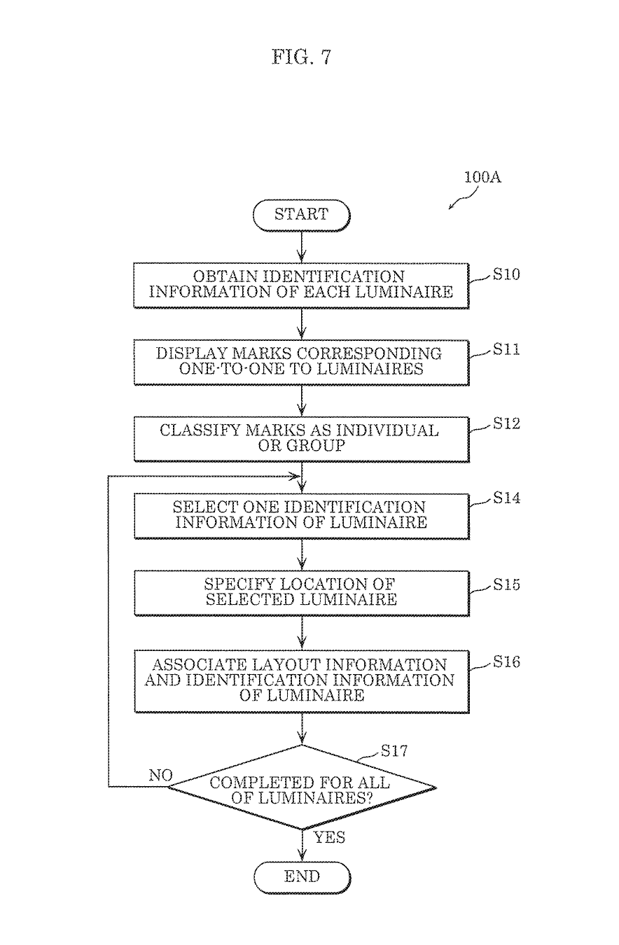

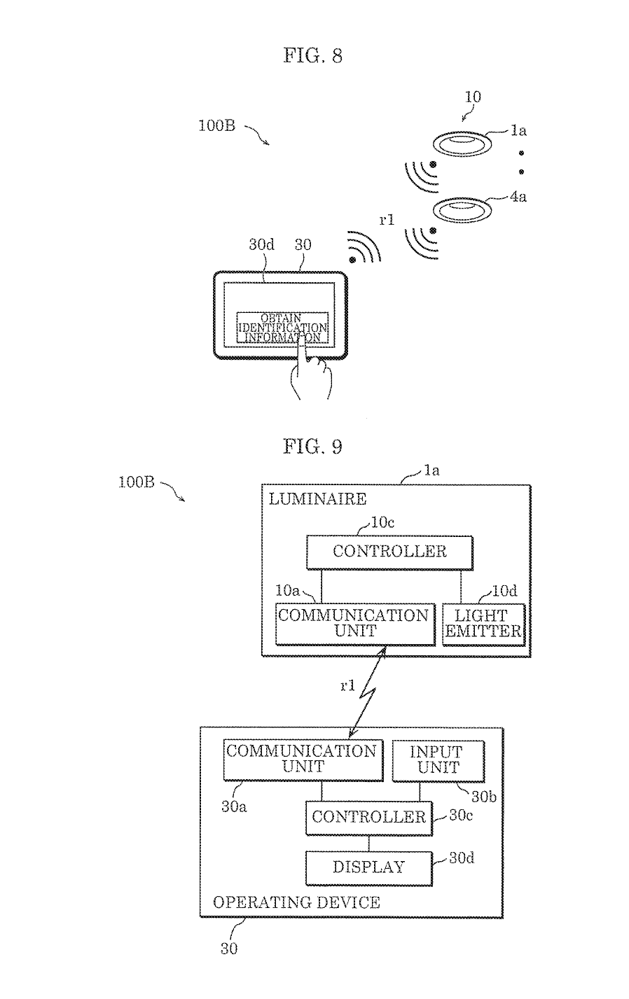

The following describes lighting system 100B according to Embodiment 3, with reference to FIG. 8 and FIG. 9. Lighting system 100B is different from lighting system 100 according to Embodiment 1 in that lighting system 100B includes neither a host controller nor wireless controllers.

FIG. 8 is a schematic diagram illustrating luminaires 1a through 4a included in lighting system 100B, and operating device 30. FIG. 9 is a block diagram illustrating the configuration of lighting system 100B.

Lighting system 100B includes luminaires 1a through 4a and operating device 30. Although FIG. 1 illustrates four luminaires, more than hundred luminaires are actually installed, for example, in the ceiling of a building in some cases. Hereinafter, a part or all of luminaires 1a through 4a may be referred to as luminaires 10.

Luminaires 10 are each capable of communicating with operating device 30 over radio r1, as illustrated in FIG. 8 and FIG. 9. Operating device 30 is a setter that performs mapping, Upon the aforementioned mapping and pairing between each luminaire 10 and operating device 30, operating device 30 becomes capable of controlling the lighting of luminaires 10.

Lighting system 100B includes luminaires 10 to be individually controlled by operating device 30 and at least two luminaires 10 to be controlled as a group by operating device 30. When mapping is performed in lighting system 100B, luminaires 10 to be individually controlled are displayed individually while luminaires 10 to be controlled as a group are displayed in a group, on operating device 30.

Lighting system 100B according to this embodiment includes luminaires 10 and operating device 30 that associates identification information held by each luminaire 10 with layout information of luminaires 10. Operating device 30 includes display 30d that displays, based on the layout information, marks M corresponding one-to-one to luminaires 10 and mark group G that includes, among marks M, at least two marks M corresponding one-to-one to at least two luminaires 10 among luminaires 10.

Thus, with the display, on display 30d, of mark group G that includes at least two marks M, it is possible, in lighting system 100B, to easily associate the identification information of luminaire 10 with the layout information.

### Other Embodiments

Although a lighting system, an operating device, and a mapping method for use in the lighting system have been described so far based on the embodiments and variation, the present disclosure shall not be limited to the aforementioned embodiments and variation. Forms obtained by various modifications to the foregoing embodiment that can be conceived by a person skilled in the art as well as forms realized by arbitrarily combining elements and functions in the embodiment which are within the scope of the essence of the present disclosure, for example, are included in the present disclosure.

Mark group G is created or mapping is performed by display 30d, which is a touch panel, being touched, in Embodiment 1, but the creation of mark group G or the mapping method shall not be limited to such. For example, operating device 30 may have input unit 30b such as a mouse, and create mark group G or perform mapping by operating this input unit 30b.

Moreover, the user specifies the location of luminaire 10 that flashes by visual confirmation, in Step S15 of Embodiment 1, but the method to specify the location of luminaire 10 shall not be limited to such. For example, operating device 30 may include an image sensor such as a camera, and specify, using this image sensor, the location of luminaire 10 that flashes.

While the foregoing has described one or more embodiments and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

What is claimed is:

1. A lighting system comprising:
luminaires; and
an operating device that associates identification information held by each of the luminaires and layout information of the luminaires, wherein
the operating device includes a display that displays marks and a mark group based on the layout information, the marks corresponding one-to-one to the luminaires, the mark group including, among the marks, at least two marks corresponding one-to-one to at least two luminaires among the luminaires, the mark group being displayed in a distinguishable manner from one or more marks not included in the mark group.

2. The lighting system according to claim 1, wherein:
the operating device includes a controller that creates the mark group upon receiving a selection input including the at least two marks among the marks displayed on the display, and
after having created the mark group, the controller causes the display to display the mark group.

3. The lighting system according to claim 2, wherein
the controller creates the mark group upon receiving, as the selection input on the display, either touch inputs for selecting or an input for enclosing the at least two marks among the marks displayed on the display.

4. The lighting system according to claim 3, wherein
the controller stores the layout information of the luminaires, and upon receiving an input of the identification information of one luminaire among the luminaires, for one mark among the marks displayed on the display, associates the layout information with the identification information.

5. The lighting system according to claim 3, wherein
the controller stores layout information of the at least two luminaires corresponding one-to-one to the at least two marks included in the mark group, and upon receiving an input of identification information of the at least two luminaires, for the mark group displayed on the display, associates the layout information with the identification information.

6. The lighting system according to claim 1, wherein
the at least two luminaires corresponding one-to-one to the at least two marks included in the mark group are controlled as a group.

7. An operating device comprising:
a display that displays marks and a mark group based on layout information of luminaires before associating identification information held by each of the luminaires with the layout information, the marks corresponding one-to-one to the luminaires, the mark group including, among the marks, at least two marks corresponding one-to-one to at least two luminaires among the luminaires.

8. A mapping method, which is for use in a lighting system including an operating device and luminaires, for associating identification information held by each of the luminaires with layout information of the luminaires, the mapping method comprising:
displaying, on the operating device, marks and a mark group based on the layout information, the marks corresponding one-to-one to the luminaires, the mark group including at least two marks among the marks;
obtaining pieces of identification information, each being obtained from one of the luminaires; and
associating, with the mark group displayed on the operating device, at least two pieces of identification information among the pieces of identification information obtained.

9. The mapping method according to claim 8, wherein
the associating includes associating, with each of the marks displayed on the operating device, one of the pieces of identification information obtained.

10. The mapping method according to claim 8, wherein
the obtaining and the associating are performed in a listed order after the displaying.

11. The mapping method according to claim 8, wherein
the displaying and the associating are performed in a listed order after the obtaining.
